(19) United States
(12) Patent Application Publication
(10) Pub. No.: US 2011/0194211 A1
(43) Pub. Date: Aug. 11, 2011

(54) DISK DRIVE

(75) Inventor: Toshiaki ABE, Nishitama-gun (JP)

(73) Assignee: KABUSHIKI KAISHA TOSHIBA, Tokyo (JP)

(21) Appl. No.: 13/008,781

(22) Filed: Jan. 18, 2011

(30) Foreign Application Priority Data
Feb. 8, 2010 (JP) 2010-025599

(51) Int. Cl. G11B 5/54; G11B 21/22

(52) U.S. Cl. 360/256.2; 360/256.5; G9B/5.181; G9B/21.027

(57) ABSTRACT

According to one embodiment, a disk drive includes a rotatable carriage which supports a head configured to read information from a disk recording medium and to write data to the a disk recording medium, and a latch mechanism configured to latch and hold the carriage in a retracted position when subjected to an external force with the carriage in the retracted position. The latch mechanism includes an engaging portion on the carriage, a first latch pivotably provided on a base in a first mode and includes a latch lug configured to engage the engaging portion, and a second latch pivotably provided on the base in a second mode different from the first mode and includes a latch lug configured to engage the engaging portion.

### CROSS-REFERENCE TO RELATED APPLICATIONS

This application is based upon and claims the benefit of priority from Japanese Patent Application No. 2010-025599, filed Feb. 8, 2010; the entire contents of which are incorporated herein by reference.

### FIELD

Embodiments described herein relate generally to a disk drive comprising a latch mechanism for a carriage.

### BACKGROUND

In recent years, magnetic disk drives, for example, have become widely used as high-capacity disk units in electronic equipment, such as personal computers. In general, a magnetic disk drive comprises a magnetic disk, spindle motor, rotatable carriage, voice coil motor (VCM), board unit, etc. The magnetic disk is disposed in a case. The spindle motor supports and rotates the disk. The carriage supports a magnetic head. The VCM, which drives the carriage, comprises a voice coil on the carriage and a pair of yokes and permanent magnet mounted on the case side.

The magnetic disk drive constructed in this manner requires a function to prevent the carriage that holds the head from rotating and moving the head to a region above the magnetic disk in a non-operational state such that the disk is not rotating. Normally, the carriage has its centers of rotation and gravity coincident with each other and does not rotate even if it is subjected to a translational impact. If a rotational impact is applied, however, the carriage may rotate by its inertia, thereby moving the head to the region above the disk. To overcome this, a proposed magnetic disk drive comprises a latch mechanism that can prevent rotation of the carriage despite the rotational impact thereon. If a rotational impact is applied to the magnetic disk drive in a non-operational state, the latch mechanism engages with the carriage to prevent its pivoting motion, thereby holding the carriage in a retracted position.

Latch mechanisms can be roughly classified into two types, inertia latches (e.g., Japanese Patent No. 3581346) and single latches (e.g., Jpn. Pat. Appln. KOKAI Publication No. 2009-59465).

An inertia latch comprises two components, an inertia lever (inertia part) that serves as a starting point of the operation of the mechanism and a latch (latch part) that catches the carriage. If a rotational impact is applied, the inertia lever pivots to push and turn the latch, whereupon the latch is caught by a lug on the carriage. Thus, an unexpected loading action of the carriage is prevented.

On the other hand, a single latch serves as a starting point of the operation in itself without having the lever function described above, and is configured to be activated by interface repulsion from another component or by engagement with the carriage. This single latch is constructed so that the operations of the two components of the inertia latch are implemented by a single component.

If the inertia latch is subjected to a rotational impact, the latch lever cannot move to a position where it does not retard the carriage rotation unless the motion of the inertia lever terminates, so that reliable latching can be performed. In order to improve the response to the rotational impact, however, the inertia lever is formed of a material of high specific gravity and is relatively heavy. This results in an increase in the weight of the disk drive and unfavorable manufacturing costs. In some cases, moreover, the inertia lever may vibrate during normal operation, thereby adversely affecting other operations.

On the other hand, the single latch is normally formed of synthetic resin and is superior to the inertia latch in the reduction in weight and costs. Since the single latch is configured so that a single component serves to overcome a bidirectional rotational impact, however, there is a slight possibility of a failure in latching, depending on the type and action timing of the rotational impact. Specifically, during the normal operation of the magnetic drive, the latch is moved to a position (unlatchable position) where it does not interfere with the carriage operation. If a rotational impact is applied to the disk drive, the latch is expected to move to a position where it retards the carriage rotation. Thus, the latch has two states for the carriage operation. When subjected to a rotational impact, the latch alternately moves to positions ahead of and behind its home position. If a plurality of rotational impacts are applied to the carriage (in normal operation) with the latch in an unlatchable region or if the carriage is rotated in a loading direction by repulsion from its own stop, therefore, the latch mechanism may not be able to latch the carriage. In this case, the magnetic head may jump out into the region above the magnetic disk, thereby causing damage to the disk or head or attractive adhesion of the head.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an HDD according to a first embodiment;

FIG. 2 is an exemplary enlarged plan view showing a part of the HDD;

FIG. 3 is an exemplary plan view of the HDD showing a state in which a carriage is in its retracted position and first and second latches of a latch mechanism in their respective stop positions;

FIG. 4 is an exemplary enlarged plan view showing the latch mechanism of the HDD with the carriage subjected to a rotational impact in a loading direction;

FIG. 5 is an exemplary enlarged plan view showing the latch mechanism of the HDD with the carriage subjected to a rotational impact in an unloading direction; and

FIG. 6 is an exemplary enlarged plan view showing the latch mechanism of the HDD with the carriage repelled in the loading direction after being subjected to the rotational impact in the unloading direction.

### DETAILED DESCRIPTION

Various embodiments will be described hereinafter with reference to the accompanying drawings.

In general, according to one embodiment, a disk drive comprises a rotatable carriage which supports a head configured to read information from a disk recording medium and to write data to the a disk recording medium; and a latch mechanism configured to latch and hold the carriage in a retracted position when subjected to an external force with the carriage in the retracted position. The latch mechanism comprises an engaging portion on the carriage, a first latch pivotably provided on a base in a first mode and comprising a latch lug configured to engage the engaging portion, and a second latch pivotably provided on the base in a second mode different from the first mode and comprising a latch lug configured to engage the engaging portion.

A hard disk drive (HDD) according to an embodiment will now be described in detail with reference to the accompanying drawings.

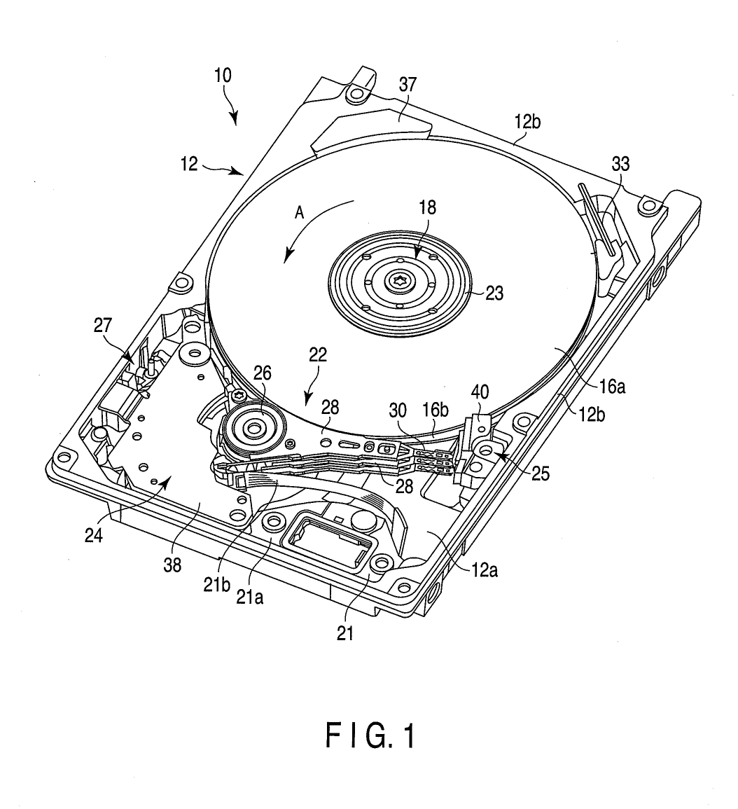

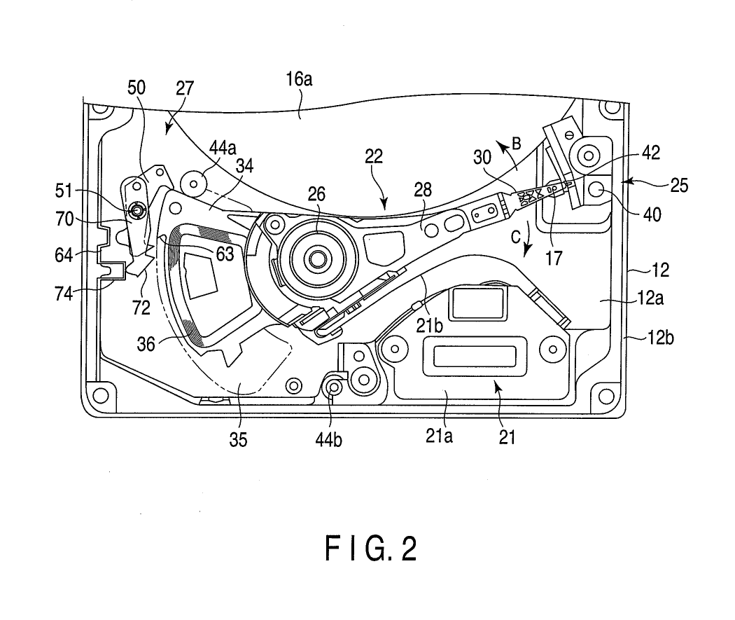

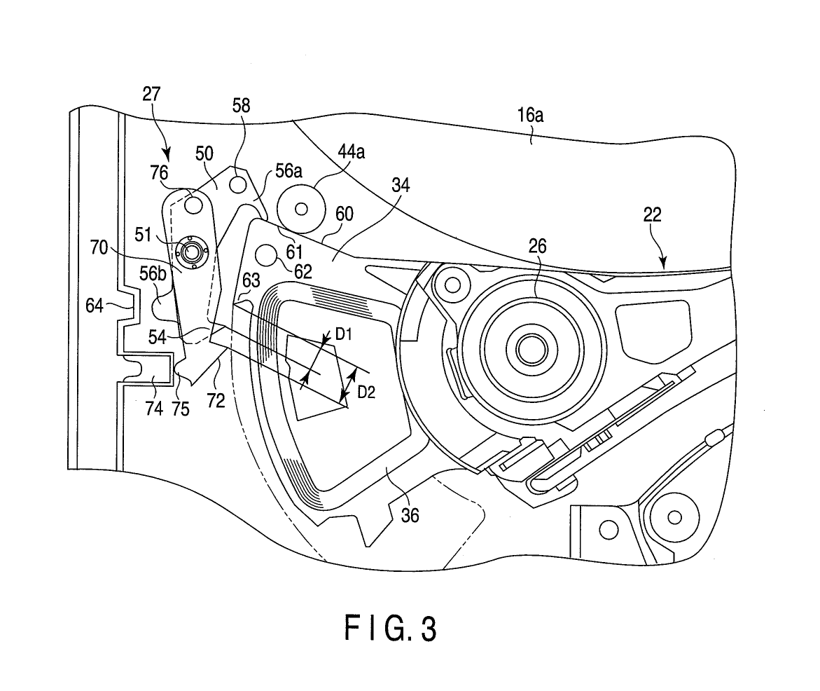

FIG. 1 shows the internal structure of the HDD with its top cover off. FIG. 2 shows a carriage and a latch mechanism portion of the HDD. FIG. 3 is an enlarged view of a latch mechanism. As shown in FIGS. 1 and 2, the HDD comprises a case 10. The case 10 comprises a base 12 in the form of an open-topped rectangular box and a top cover (not shown). The top cover is attached to the base by screws so as to close the top opening of the base. The base 12, which functions as a pedestal, comprises a rectangular bottom wall 12a and a sidewall 12b set up along the peripheral edge of the bottom wall.

The case 10 contains a spindle motor 18 as a drive unit mounted on the bottom wall 12a of the base 12 and two magnetic disks 16a and 16b that are supported and rotated by the spindle motor. Further, the case 10 contains a plurality of magnetic heads 17, carriage 22, voice coil motor (VCM) 24, ramp loading mechanism 25, latch mechanism 27, and board unit 21. The magnetic heads 17 write and read data to and from the disks 16a and 16b. The carriage 22 supports the heads for movement relative to the disks. The VCM 24 pivots and positions the carriage. The ramp loading mechanism 25 holds the magnetic heads in their respective retracted positions off the magnetic disks when the heads are moved to the outermost periphery of each disk. The latch mechanism 27 holds the carriage in its retracted position when the HDD is jolted, for example. The board unit 21 comprises a preamplifier and the like.

A printed circuit board (not shown) is attached to the outer surface of the bottom wall 12a of the base 12 by screws. This circuit board controls the operations of the spindle motor 18, VCM 24, and magnetic heads 17 through the board unit 21. The base 12 is provided with a circulation filter 33 and intake filter 37. The circulation filter 33 is used to remove dust in the case 10. The intake filter 37 serves to capture extraneous matter such as dust in the external air that is drawn into the case 10.

Each of the magnetic disks 16a and 16b for use as recording media is formed with a diameter of, for example, 65 mm (2.5 inches) and has magnetic recording layers on its upper and lower surfaces, individually. The two disks 16a and 16b are coaxially fitted on a hub (not shown) of the spindle motor 18 and clamped and secured to the hub by a clamp spring 23. Thus, the disks 16a and 16b are supported parallel to the bottom wall 12a of the base 12. The disks 16a and 16b are rotated at a predetermined speed of, for example, 5,400 or 7,200 rpm in the direction of arrow A by the spindle motor 18.

As shown in FIGS. 1 and 2, the carriage 22 comprises a bearing 26 secured to the bottom wall 12a of the base 12 and four arms 28 extending from the bearing. The bearing 26 is spaced apart from the center of rotation of the magnetic disks 6a and 6b, longitudinally relative to the base 12, and is located near the outer peripheral edges of the disks. The four arms 28 are located parallel to the surfaces of the disks and at predetermined spaces from one another and extend in the same direction from the bearing 26. The carriage 22 comprises elastically deformable suspensions 30 each in the form of an elongated plate. Each suspension 30 is formed of a leaf spring, the proximal end of which is secured to the distal end of its corresponding arm 28 by spot welding or crimping. Each suspension 30 may be formed integrally with its corresponding arm 28.

Each magnetic head 17 is mounted on an extended end of each corresponding suspension 30. The head 17 comprises a substantially rectangular slider and read/write magnetoresistive (MR) head formed on the slider. The head 17 is secured to a gimbal portion formed on the distal end portion of the suspension 30. Each two of the four magnetic heads 17 that are mounted individually on the suspensions 30 are opposed to each other so as to sandwich each of the magnetic disks 16a and 16b from both sides.

On the other hand, the carriage 22 comprises a support frame 34 that extends from the bearing 26 so as to be oriented opposite from the arms 28. The support frame supports a voice coil 36 that constitutes a part of the VCM 24. The frame 34 is a plastic structure molded integrally on the outer periphery of the voice coil 36. The voice coil 36 is located between a pair of yokes 38 secured to the base 12. The voice coil 36, along with these yokes and a magnet 35 secured to one of the yokes, constitute the VCM 24.

If the voice coil 36 is energized, the carriage 22 is pivoted about the bearing 26 between a retracted position and data processing position. In the retracted position, the magnetic heads 17 are located off the magnetic disks 16a and 16b on the outer peripheral side thereof. In the data processing position, the heads are located on the disks. Specifically, the carriage 22 is pivoted in the direction of arrow B (loading direction) and direction of arrow C (unloading direction) about the bearing 26. Thereupon, the magnetic heads 17 are moved to and positioned on desired tracks of their corresponding magnetic disks 16a and 16b. Thus, the heads 17 can write or read data to or from the disks 16a and 16b. The carriage 22 and VCM 24 constitute a head actuator. When the HDD is operating, the magnetic disks 16a and 16b are rotated at high speed by the spindle motor 18. Thereupon, each magnetic head 17 is caused to fly off a surface of its corresponding disk by airflow that is produced between itself and the disk surface, and is kept off contact with the disk surface.

First and second securing stops 44a and 44b, each in the form of a pin, are set up on the bottom wall 12a. The first securing stop 44a is disposed in a position where it is hit by the support frame 34 of the carriage 22 when the carriage is pivoted to the retracted position. Thus, the first securing stop 44a keeps the carriage 22 from excessively moving toward the retracted position of the carriage, that is, in the unloading direction C. The second securing stop 44b is disposed in a position where it is hit by the support frame 34 when the carriage 22 is pivoted to the innermost peripheral side of the magnetic disks 16a and 16b. Thus, the second securing stop 44b keeps the carriage 22 from excessively moving toward the data processing position of the carriage, that is, in the loading direction B. The first and second securing stops 44a and 44b are made elastic in order to absorb an impact when they contact the support frame 34. For example, the respective surfaces of the first and second securing stops 44a and 44b are covered by an elastic material, such as synthetic resin or rubber.

As shown in FIGS. 2 and 3, the support frame 34 of the carriage 22 is formed with a stop contact surface 60 and latch contact portion 61. The stop contact surface 60 functions as a stop contact portion that contacts the first securing stop 44a. The latch contact portion 61 contacts a first latch (an unloading latch) 50 of the latch mechanism 27, which will be described later. A first magnetically attractable portion 62 of a magnetic material, such as stainless steel, is formed near the latch contact portion 61 on the support frame 34. The first magnetically attractable portion 62 is magnetically attracted to the magnet 35 or lower yoke of the VCM 24 and urges the carriage 22 toward the retracted position, that is, to contact the first securing stop 44a. Further, an outwardly projecting engaging lug 63 is integrally formed near the latch contact portion 61 on the support frame 34. The engaging lug 63 constitutes an engaging portion of the latch mechanism 27.

As shown in FIGS. 1 and 2, the ramp loading mechanism 25 comprises a ramp 40, disposed on the bottom wall 12a of the base 12 and located outside the magnetic disks 16a and 16b, and tabs 42 extending individually from the respective distal ends of the suspensions 30. The ramp 40 is located downstream of the bearing 26 with respect to the direction of rotation A of the disks 16a and 16b. When the carriage 22 pivots so that the magnetic heads 17 are pivoted to the retracted position outside the disks 16a and 16b, each of the tabs 42 engages with a corresponding ramp surface formed on the ramp 40 and is impelled up the ramp to unload the heads 17.

The board unit 21 comprises a main body 21a, which is formed of a flexible printed circuit board and secured to the bottom wall 12a of the base 12. Electronic components, including a head amplifier, are mounted on the body 21a. The board unit 21 comprises a main flexible printed circuit board (main FPC) 21b extending from the body 21a. An extended end of the main FPC 21b is connected to the vicinity of the bearing 26 of the carriage 22. Further, the extended end is electrically connected to the magnetic heads 17 by cables (not shown) on the arms 28 and suspensions 30. Connectors (not shown) for connection with the printed circuit board are mounted on the bottom surface of the main body of the board unit 21.

FIG. 3 is an enlarged view of the latch mechanism 27. As shown in FIGS. 2 and 3, the latch mechanism 27 comprises the first latch (unloading latch) 50, a second latch (loading latch) 70, and the engaging lug 63. The first latch 50 latches the carriage 22 in response to a rotational impact in the unloading direction C. The second latch 70 latches the carriage 22 in response to a rotational impact in the loading direction B. The engaging lug 63 protrudes from the support frame 34 of the carriage 22. The first and second latches 50 and 70 are, for example, plastic plates, which are supported for pivoting motion about a common pivot shaft 51 on the bottom wall 12a of the base 12. The latches 50 and 70 are arranged on the support frame 34 of the carriage 22.

The first and second latches 50 and 70 are configured to operate in different modes. For example, the first latch 50 comprises a contact portion that contacts the carriage 22 and operates based on a reactive force received from the carriage. The second latch 70 engages with neither the first latch nor the contact portion in contact with the carriage 22 and operates based on the inertia force.

The first latch 50 has its substantially central portion pivotably supported by the pivot shaft 51 so that its center of gravity is coincident with the center of rotation. The first latch 50 is an integrally molded structure of synthetic resin or the like, which comprises a first latch lug 54 and first and second contact portion 56a and 56b. The first latch lug 54 extends from the pivot shaft 51 and can engage with the engaging lug 63 of the support frame 34. The first contact portion 56a extends substantially at right angles to the first latch lug 54 from the pivot shaft and can contact the latch contact portion 61 of the support frame 34. The second contact portion 56b can contact a latch stop 64 formed on the base 12.

The first latch 50 is supported so as to be pivotable about the pivot shaft 51 between a latch position and release position. In the latch position, the first latch lug 54 is located within the movement path of the engaging lug 63 of the support frame 34 and can latch the carriage 22. In the release position, the latch is released to allow the carriage 22 to pivot.

The second contact portion 56b of the first latch 50 is disposed on the side of the first latch lug 54 with respect to the pivot shaft 51. The latch stop 64 keeps the first latch 50 from excessively pivoting toward the release position. In the release position, the second contact portion 56b of the first latch 50 contacts the latch stop 64, thereby preventing the first latch 50 from pivoting. Further, the first latch 50 is kept from excessively pivoting toward the latch position as the first latch lug 54 contacts the outer peripheral surface of the support frame 34.

The first latch 50 comprises a second magnetically attractable portion 58 disposed on the opposite side of the pivot shaft 51 from the first latch lug 54. The second magnetically attractable portion 58 comprises a magnetic ball of stainless steel or the like embedded in the first latch 50. The second magnetically attractable portion 58 is magnetically attracted to the magnet 35 or lower yoke of the VCM 24 and urges the first latch 50 toward the release position, that is, in a direction such that the first contact portion 56a contacts the support frame 34 of the carriage 22.

The second latch 70 has its intermediate portion pivotably supported by the pivot shaft 51 so that its center of gravity is coincident with the center of rotation. The second latch 70 is an integrally molded structure of synthetic resin or the like, which comprises a second latch lug 72 and third contact portion 75. The second latch 70 extends from the pivot shaft 51 and can engage with the engaging lug 63 of the support frame 34. The third contact portion 75 can contact a latch stop 74 formed on the base 12.

The second latch 70 is supported so as to be pivotable about the pivot shaft 51 between a latch position and release position. In the latch position, the second latch lug 72 is located within the movement path of the engaging lug 63 of the support frame 34 and can latch the carriage 22. In the release position, the latch is released to allow the carriage 22 to pivot.

The first and second latches 50 and 70 are formed so that distance D2 between the second latch lug 72 of the second latch 70 and the engaging lug 63 of the carriage 22 is more than distance D1 between the first latch lug 54 of the first latch 50 and the engaging lug 63 when the carriage 22 is moved to the retracted position shown in FIG. 3. Specifically, the second latch 70 is formed so that the distance between the pivot shaft 51 and second latch lug 72 is more than that between the first latch lug 54 and the pivot shaft of the first latch 50.

The second latch 70 comprises a third magnetically attractable portion 76 disposed on the opposite side of the pivot shaft 51 from the second latch lug 72. The third magnetically attractable portion 76 comprises a magnetic ball of stainless steel or the like embedded in the second latch 70. The third magnetically attractable portion 76 is magnetically attracted to the magnet 35 or lower yoke of the VCM 24 and urges the second latch 70 toward the release position, that is, in a direction such that the third contact portion 75 contacts the latch stop 74 of the base 12.

If the HDD is stopped or subjected to an external force, such as an impact, the latch mechanism 27 constructed in this manner latches the carriage 22 in the retracted position by means of the inertia forces of the first and second latches 50 and 70, magnetic attractive force thereon, and reactive force from the carriage 22. In this way, the latch mechanism 27 prevents the carriage from moving from the retracted position to the data processing position.

FIG. 3 shows the carriage 22 and latch mechanism 27 with the HDD non-operational. If the carriage 22 is pivoted from the data processing position to the illustrated retracted position in the non-operational HDD, the stop contact surface 60 of the support frame 34 contacts the first securing stop 44a. As the first magnetically attractable portion 62 of the support frame 34 is magnetically attracted to the magnet 35, moreover, the carriage 22 is held in the illustrated retracted position where the stop contact surface 60 contacts the first securing stop 44a. Since the first securing stop 44a is elastic, it can absorb an impact produced as the support frame 34 contacts it, so that a collision sound is suppressed.

If the carriage 22 is pivoted to the retracted position, the latch contact portion 61 of the support frame 34 contacts and presses the first contact portion 56a of the first latch 50. Thereupon, the first latch 50 pivots counterclockwise about the pivot shaft 51 and moves to the illustrated latch position. When this is done, the first latch 50 is urged clockwise about the pivot shaft 51 by the magnetic attractive force of the second magnetically attractable portion 58, so that it is pivoted and held in the illustrated stop position with the first contact portion 56a pressed against the latch contact portion 61 of the support frame 34. In this stop position, the first latch lug 54 of the first latch 50 is deviated slightly outward from the movement path of the engaging lug 63. In the stop position, the first latch 50 is positioned only by contacting the carriage 22 and is not in contact with any other part of the base 12 than those regions around the pivot shaft 51.

Since the second latch 70 is urged clockwise about the pivot shaft 51 by the magnetic attractive force of the third magnetically attractable portion 76, the third contact portion 75 contacts the latch stop 74 of the base 12 and is held in the illustrated release position.

In the latch mechanism 27 constructed in this manner, the first and second latches are designed depending on the direction (loading direction B or unloading direction C) in which the carriage 22 is first caused to rotate by the rotational impact that acts on the HDD. When the HDD is non-operational, the carriage 22 is in stationary contact with the preloaded first securing stop 44a. During normal operation of the HDD, the first and second latches 50 and 70 are retracted to positions where they do not interfere with the action of the carriage 22.

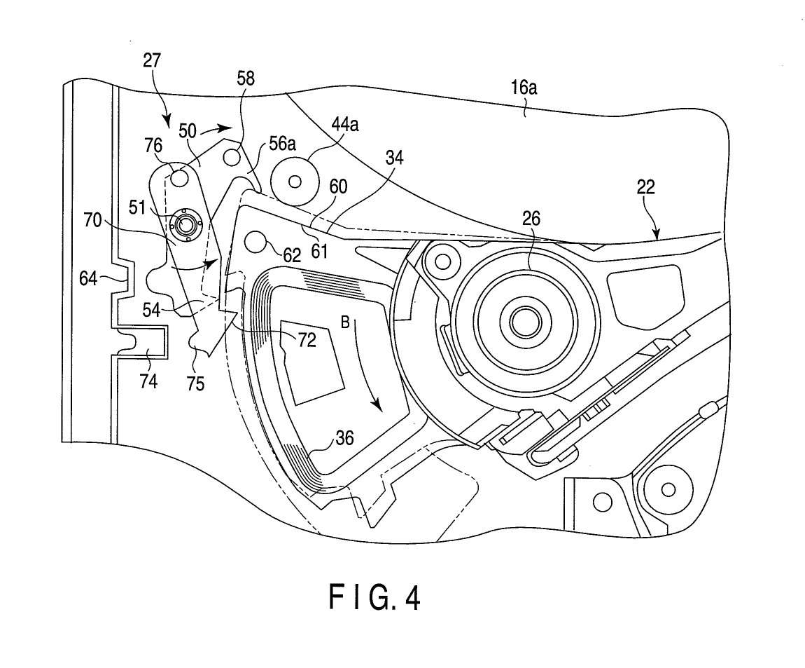

If the carriage 22 is jolted so as to rotate in the loading direction B, as shown in FIG. 4, it is caused to abruptly start rotating in the loading direction B by the inertia force of the carriage 22. On the other hand, the second latch 70 having so far been on standby in the retracted position also rotates in a direction such that the second latch lug 72 moves toward the carriage 22, thereby latching the carriage. The moment of inertia of the carriage 22 is higher than that of the second latch 70. If the carriage 22 is jolted and abruptly moves forward in the loading direction B, therefore, it takes a long time before the second latch lug 72 starts to move toward the carriage 22, since the second latch 70 has a low moment of inertia and moves from a standby position where it does not interfere with the action of the carriage 22. Therefore, the second latch lug 72 of the second latch 70 is formed so as to be located at distance D2 from the engaging lug 63 of the carriage 22 when the carriage 22 is in the retracted position. Thus, the distance from the retracted position of the engaging lug 63 of the carriage 22 to a position where it crosses the second latch lug 72, that is, a latchable range, is extended to stall for time before the engaging lug 63 is deviated from the latchable range. Consequently, the carriage 22 can be reliably latched by the second latch 70.

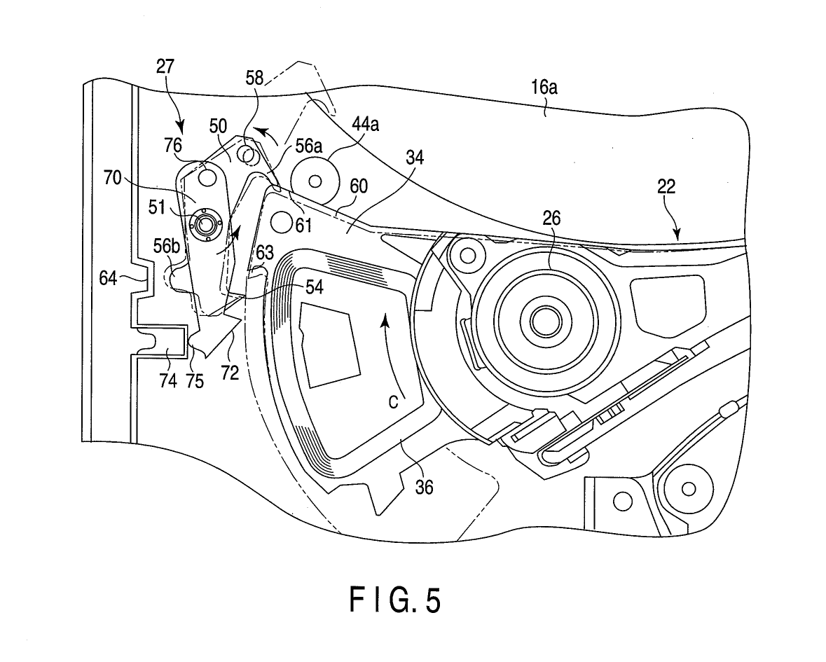

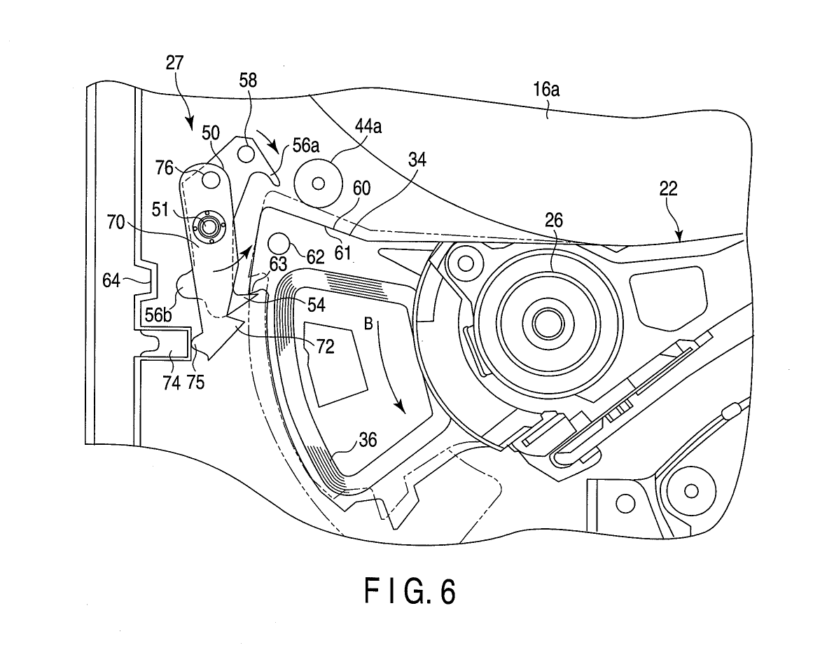

If a rotational impact is applied to the carriage 22 such that the carriage rotates in the unloading direction C, as shown in FIG. 5, the carriage temporarily pivots in the unloading direction C to be pressed against the first securing stop 44a. Thereafter, the carriage 22 is caused to change its direction of rotation in the loading direction B by the repulsion of the first securing stop 44a. Since the first latch 50 is in direct contact with the carriage 22, on the other hand, the first latch lug 54 abruptly starts to move toward the carriage as the carriage pivots in the unloading direction C. In this way, the carriage 22 and first latch 50 behave oppositely and a time lag occurs when they engage with each other. However, distance D1 between the first latch lug 54 and the engaging lug 63 of the carriage 22 is less than distance D2 between the first latch lug 54 and engaging lug 63. As shown in FIG. 6, therefore, the engaging lug 63 of the carriage 22 engages with the second latch lug 72 as soon as it is moved in the loading direction B. Thus, the carriage 22 can be latched by the first latch 50 almost the moment the rotational impact in the unloading direction C is applied to it.

As described above, the latch mechanism 27 can be independently designed with an emphasis on their respective principal motions by providing two latches for different operation modes, that is, by providing the first latch 50 for an unloading mode and the second latch 70 for a loading mode. A conventional single latch involves a moment when it is fully open, and it may fail to catch the carriage 22 at that moment. According to the present embodiment, however, the latch mechanism 27 comprises the first and second latches that act independently of each other. Therefore, the effect of an open state of one latch can be compensated for by the other latch, so that the carriage 22 can be latched more reliably.

Since the necessary absolute value of the moment of inertia of each of the first and second latches is less than that of an inertia latch, moreover, the possibility of components overrunning and undergoing self-disturbed vibration within the apparatus when subjected to disturbance, such as vibration, can be reduced. The latch mechanism 27 can reduce the apparatus weight more than the inertia latch can.

According to the HDD constructed in this manner, the latch mechanism 27 can suppress an unexpected movement of the carriage 22, thereby preventing the magnetic heads from being damaged by hitting the magnetic disks 16, if an external force in any direction acts on the HDD. Even if a plurality of rotational impacts are sequentially applied, one of the latches moves ahead of or at least simultaneously with the carriage to the engagement side. Therefore, there is no possibility of a latching failure, so that the reliability of the latch mechanism can be improved. Thus, there may be obtained a magnetic disk drive that is highly immune to impact.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the first and second latches are not limited to the arm-like shapes and may be of various other shapes. The number of magnetic disks is not limited to two and may be varied as required. Further, the magnetic disks are available in any size, e.g., 3.5, 2.5 or 1.8 inches.

What is claimed is:

1. A disk drive comprising:
a rotatable carriage which supports a head configured to read information from a disk recording medium and to write data to the disk recording medium; and
a latch mechanism configured to latch and hold the carriage in a retracted position when subjected to an external force with the carriage in the retracted position,
wherein the latch mechanism comprises an engaging portion on the carriage, a first latch pivotably provided on a base in a first mode and comprising a latch lug configured to engage the engaging portion, and a second latch pivotably provided on the base in a second mode different from the first mode and comprising a latch lug configured to engage the engaging portion.

2. The disk drive of claim 1, wherein the first and second latches are pivotably supported around a common rotational axis.

3. The disk drive of claim 1, wherein the first and second latches are pivotably supported around a common rotational axis and have respective centers of gravity thereof on the rotational axis.

4. The disk drive of claim 1, wherein the first latch comprises a contact portion configured to contact the carriage and to cause the first latch to pivot from a release position toward the carriage when the carriage is pivoted from a data processing position to the retracted position.

5. A disk drive comprising:
a rotatable carriage which supports a head configured to read information from a disk recording medium and to write data to the disk recording medium; and
a latch mechanism configured to latch and hold the carriage in a retracted position when subjected to an external force with the carriage in the retracted position,
wherein the latch mechanism comprises an engaging portion on the carriage, a first latch pivotably provided on a base and comprising a latch lug configured to engage the engaging portion, and a second latch provided on the base, pivotably about a rotational axis shared with the first latch and comprising a latch lug configured to engage the engaging portion, and
wherein a distance between the latch lug of the first latch and the rotational axis is different from a distance between the latch lug of the second latch and the rotational axis.

6. The disk drive of claim 5, further comprising a first magnetically attractable portion on the carriage and configured to urge the carriage toward the retracted position, and
a first securing stop on the base and configured to contact the carriage to position the carriage in the retracted position when the carriage is moved to the retracted position.

7. The disk drive of claim 6, wherein the latch mechanism comprises a second magnetically attractable portion on the first latch and configured to urge the first latch toward a release position in which the latch lug of the first latch is deviated from a trajectory of the engaging portion, and a third magnetically attractable portion on the second latch and configured to urge the second latch toward a release position in which the latch lug of the second latch is deviated from the trajectory of the engaging portion.

8. The disk drive of claim 7, further comprising a latch stop configured to contact the first latch pivoted to the release position and the second latch pivoted to the release position.

9. The disk drive of claim 7, wherein the contact portion of the first latch and the second magnetically attractable portion are located on the opposite side of the rotational axis from the lug.

10. The disk drive of claim 7, further comprising a motor comprising a magnet on the base and a coil disposed on the carriage opposite to the magnet and configured to pivot the carriage, wherein the carriage comprises a bearing pivotably supported on the base, an arm extending from the bearing and supporting the head, and a support frame extending from the bearing in a direction opposite to the arm and supporting the coil, and the first, second, and third magnetically attractable portions are located in positions where the magnetically attractable portions are magnetically attracted by the magnet.

11. A disk drive comprising:
a rotatable carriage which supports a head configured to read information from a disk recording medium and to write data to the disk recording medium; and
a latch mechanism configured to latch and hold the carriage in a retracted position when subjected to an external force with the carriage in the retracted position, wherein
the latch mechanism comprises an engaging portion on the carriage, a first latch pivotably provided on a base, configured to pivot as the carriage pivots, and comprising a latch lug configured to engage the engaging portion and a contact portion configured to contact the carriage moved to the retracted position, and a second latch provided on the base, pivotably about a rotational axis shared with the first latch, configured to pivot by inertia, and comprising a latch lug configured to engage the engaging portion.

12. The disk drive of claim 11, further comprising a first magnetically attractable portion on the carriage and configured to urge the carriage toward the retracted position, and
a first securing stop on the base and configured to contact the carriage to position the carriage in the retracted position, when the carriage is moved to the retracted position.

13. The disk drive of claim 12, wherein the latch mechanism comprises a second magnetically attractable portion on the first latch and configured to urge the first latch toward a release position in which the latch lug of the first latch is deviated from a trajectory of the engaging portion, and a third magnetically attractable portion on the second latch and configured to urge the second latch toward a release position in which the latch lug of the second latch is deviated from the trajectory of the engaging portion.

14. The disk drive of claim 13, further comprising a latch stop configured to contact the first latch pivoted to the release position and the second latch pivoted to the release position.

15. The disk drive of claim 13, wherein the contact portion of the first latch and the second magnetically attractable portion are located on the opposite side of the rotational axis from the lug.

16. The disk drive of claim 13, further comprising a motor comprising a magnet on the base and a coil disposed on the carriage opposite to the magnet and configured to pivot the carriage, wherein the carriage comprises a bearing pivotably supported on the base, an arm extending from the bearing and supporting the head, and a support frame extending from the bearing in a direction opposite to the arm and supporting the coil, and the first, second, and third magnetically attractable portions are located in positions where the magnetically attractable portions are magnetically attracted by the magnet.
